(19) United States
(12) Patent Application Publication
(10) Pub. No.: US 2012/0295489 A1
(43) Pub. Date: Nov. 22, 2012

(54) ELECTRONIC COMPONENT SOCKET

(75) Inventors: Takeki UOZUMI, Miyagi-ken (JP); Kazuki SATO, Miyagi-ken (JP); Yoshimasa KURODA, Miyagi-ken (JP)

(73) Assignee: Alps Electric Co., Ltd., Ota-ku (JP)

(21) Appl. No.: 13/470,566

(22) Filed: May 14, 2012

(30) Foreign Application Priority Data
May 18, 2011 (JP) 2011-110986

(51) Int. Cl. H01R 24/76

(52) U.S. Cl. 439/660

(57) ABSTRACT

A plurality of intermediate terminal portions are evenly arranged and held in an insulating housing. Each intermediate terminal portion has a structure in which a first metal piece and a second metal piece overlap each other. In the first metal piece, a curved portion and a flat portion form a first elastic piece. In the second metal piece, a curved portion and a flat portion form a second elastic piece. When an external force is not exerted, the first elastic piece of the first metal piece and the second elastic piece of the second metal piece are separated from each other. When the intermediate terminal portion is pressed against the component electrode portion of the electronic component, first only the first metal piece is deformed, and then the first metal piece and the second metal piece are deformed together.

### CLAIM OF PRIORITY

This application contains subject matter related to and claims the benefit of Japanese Patent Application No. 2011-110986 filed on May 18, 2011, the entire contents of which is incorporated herein by reference.

### BACKGROUND OF THE DISCLOSURE

1. Field of the Disclosure

The present disclosure relates to an electronic component socket which supports an electronic component such as an IC chip, and particularly, to an electronic component socket of which a terminal portion stably and elastically contacts an electrode portion provided in a bottom surface of an electronic component.

2. Description of the Related Art

Japanese Patent No. 3284342 discloses a socket which supports an electronic component such as an IC chip. In the socket, an insulating board is fixed into a frame installed on a printed circuit board, and the insulating board is provided with plural terminal portions (contacts) formed as plate springs.

When an electronic component having plural electrode portions provided in the bottom surface is attached to a frame, a terminal portion (a contact) which is formed as a plate spring is bent by being pressed against the electrode portion of the electronic component, and the terminal portion and the electrode portion come into press-contact with each other by the elastic reaction force so as to be electrically connected to each other.

When an intensive load is applied to the terminal portion of the plate spring which is a cantilevered beam, the terminal portion is bent. At this time, the bending amount of the terminal portion is large when its free length is long and its second moment of area is small and vice versa. That is, in a case where the section of the terminal portion is constant, the spring constant becomes small when the free length is long and becomes large when the free length is short.

When the free length of the terminal portion is made long, the elastic reaction force generated when the terminal portion comes into contact with the electrode portion of the electronic component decreases. Accordingly, in order to allow the terminal portion to reliably contact the electrode portion of the electronic component, the bending amount of the terminal portion needs to be made large. However, when the bending amount of the terminal portion is made large, the arrangement pitch of the terminal portions is not easily made short, and the terminal portion may not be applied to the socket which supports the electronic component with high arrangement density of the electrode portions.

On the contrary, when the free length of the terminal portion is made short, the elastic reaction force generated when the terminal portion contacts the electrode portion of the electronic component increases, and the attachment of the electronic component is not easily performed. In order to shorten the free length of the terminal portion and decrease the spring constant, the second moment of area needs to be small. However, when the second moment of area is small, the section modulus decreases, and the maximal stress which is exerted in the base end portion of the terminal portion increases, thereby degrading the strength and the lifespan of the terminal portion.

In a connector which is disclosed in U.S. Pat. No. 7,780,456, plural elastic contacts are attached to an insulating housing, and each contact has a structure in which two branched contact terminals come into close contact with a lower portion of a base contact terminal.

According to the disclosure of U.S. Pat. No. 7,780,456, enough elasticity and strength may be exhibited due to the multi-structure of the contact when the electronic component is mounted so that the contact is pressed.

As disclosed in U.S. Pat. No. 7,780,456, when a plurality of the elastically deformed contact terminals are piled up, the pressing force of the electrode portion of the electronic component may be distributed to the plurality of contact terminals. Since the load which is exerted in one contact terminal decreases with the number of the contact terminals, the bending moment which is exerted in individual contact terminal may be decreased, and even when the section modulus of the contact terminal is decreased, the maximal stress which is exerted in the contact terminal does not increase too much. As a result, even when the free length of the contact is short, the appropriate elastic reaction force may be exhibited and the strength and the lifespan may be improved.

However, the connector disclosed in U.S. Pat. No. 7,780,456 has a structure in which three contact terminals come into close contact with each other in a state where no external force is exerted. For this reason, until the electronic component is completely attached to the housing after the electrode portion of the electronic component starts to contact the terminal, the elastic reaction force which is exerted from the terminal to the electrode portion of the electronic component is large. Since plural terminals are provided so as to match the number of the electrode portions of the electronic component, the reaction force generated when the electronic component is attached to the housing increases to a large extent.

Further, when the contact is pressed against the electrode portion, the plural contact terminals are normally bent in a close contact state. For this reason, the mutual frictional force of the contact terminals is generated, and the resistance force generated when the contact is bent increases. Further, the elastic force for each contact may easily become non-uniform due to a variation in the frictional force.

These and other drawbacks exist.

### SUMMARY OF THE DISCLOSURE

The embodiments of the present disclosure provide an electronic component socket capable of shortening a free length of a terminal portion and allowing a terminal portion to contact an electrode portion of an electronic component with an appropriate reaction force in an appropriate contact state.

According to an embodiment, an electronic component socket includes: a housing that includes a component support portion in which an electronic component is able to be installed; and terminal portions that are fixed to the housing and are able to contact a plurality of component electrode portions provided in a bottom surface of the electronic component, wherein each terminal portion includes a support piece fixed to an insulation holding portion inside the housing and first and second elastic pieces extending from the insulation holding portion toward the component support portion, wherein when the electronic component is installed in the component support portion, the first elastic piece is bendable toward a first side by being pressed against the component electrode portion, wherein the second elastic piece is positioned at the first side in relation to the first elastic piece and when an external force is not exerted in the terminal portion, the second elastic piece is separated from the first elastic piece in a range of a predetermined distance from the front end portion toward the insulation holding portion, and wherein when the first elastic piece is deformed toward the first side by a predetermined distance, the first elastic piece and the second elastic piece contact each other.

Since the electronic component socket distributes the pressing force applied from the component electrode portion through two elastic pieces, the spring constant of each elastic piece may be made low, and the maximal stress of each elastic piece may be also reduced.

Further, when the electronic component is attached to the component support portion, first the first elastic piece is deformed, and then the first elastic piece and the second elastic piece are deformed together while coming into contact with each other. For this reason, it is possible to reduce the initial reaction force generated when the electronic component is attached to the housing and to easily attach the electronic component to the electronic component socket.

Furthermore, a third elastic piece and the like may be further provided so as to reinforce the second elastic piece.

In various embodiments, when the external force is not exerted in the terminal portion, the front end portion of the second elastic piece may be positioned near the insulation holding portion in relation to the front end portion of the first elastic piece.

In the electronic component socket, the second elastic piece may be prevented from protruding outward from the deformation area of the first elastic piece when the terminal portion is bent, and the arrangement pitch of the terminal portions may be easily set to be short.

Also, both the first elastic piece and the second elastic piece may include a curved portion near the insulation holding portion, and when the external force is not exerted in the terminal portion, the second elastic piece in a range from the front end portion to the curved portion may be separated from the first elastic piece.

Since the first elastic piece and the second elastic piece are provided with the curved portion, the free lengths of the first elastic piece and the second elastic piece may be made substantially long. When the free length is lengthened, the spring constant may be decreased, and hence the section modulus increases and the maximal stress decreases with a decrease in the spring constant. Accordingly, the strength and the lifespan of the elastic piece may be improved. Further, since the first elastic piece and the second elastic piece are separated from each other in a range from the front end portion to the curved portion when the load is not exerted, the initial reaction force generated when attaching the electronic component may be made small.

When the first elastic piece is deformed by being pressed against the component electrode portion, the first elastic piece and the second elastic piece may be elastically deformed toward the first side while contacting each other at one position in the longitudinal direction.

In an exemplary electronic component socket, since the first elastic piece and the second elastic piece are deformed while contacting each other at one position in the longitudinal direction, the resistance force caused by the frictional force is not easily exerted during the deformation, and the stable reaction force may be given from the terminal portion to the electrode portion.

In various embodiments, the terminal portion may include first and second metal pieces which are independent of each other, the first metal piece may be integrally formed with the first elastic piece and a first support piece, the second metal piece may be integrally formed with the second elastic piece and a second support piece, and the first support piece and the second support piece may be held in the insulation holding portion while coming into close contact with each other.

In the electronic component socket with the above-described structure, the terminal portion includes two independent metal pieces. However, since the support piece which is a part of each metal piece is held by the insulation holding portion while coming into close contact with the insulation holding portion, the conductive resistance between the terminal portion and the component electrode portion may be distributed to two metal pieces, whereby the resistance value may be reduced.

Furthermore, the terminal portion may include one metal piece which is bent, and two elastic pieces and two support pieces may be integrally formed with each other.

The terminal portion may be provided with a base end piece that extends from the insulation holding portion toward the opposite side of the component support portion, and the base end piece may be provided with a conductive piece that is connected to a connection electrode portion facing the opposite side of the component support portion.

Further, a metal sheet may be held inside the housing, and the insulation holding portion holding a plurality of the terminal portions may be held in a penetration hole of the metal sheet.

In the above-described configuration, since the plurality of terminal portions are shielded by the metal sheet, the terminal portions are not easily affected by external noise.

Furthermore, the insulation holding body may be integrally formed with the synthetic resinous housing, and the plurality of terminal portions may be directly fixed to the housing.

Also, since the plurality of elastic pieces which form the terminal portion evenly receive the pressing force from the component electrode portion, the elastic reaction force may be appropriately set and the strength of the terminal portion may be improved. As a result, the terminal portion may be made comparatively short and the arrangement pitch of the terminal portions may be made dense.

Further, since the terminal portion includes the plurality of elastic pieces, the electrical resistance may be decreased.

### BRIEF DESCRIPTION OF THE DRAWINGS

FIG. 1 is a perspective view illustrating an electronic component socket according to an embodiment of the disclosure.

FIG. 2 illustrates the electronic component socket according to the embodiment of the disclosure and a connection member attached to a connection member attachment portion and is a cross-sectional view taken along the line II-II of FIG. 1.

FIG. 3 is a cross-sectional view illustrating a state where the connection member is attached to the electronic component socket according to the embodiment of the disclosure.

FIG. 4 is an exploded perspective view illustrating the connection member and two metal sheets.

FIG. 5 is a plan view illustrating a first metal sheet.

FIG. 6 is an exploded perspective view illustrating an insulation holding portion which holds the first metal sheet and plural intermediate terminal portions.

FIG. 7 is an enlarged view illustrating a part of FIG. 2 showing the detail of the intermediate terminal portion.

FIG. 8 is an enlarged view illustrating a state where a component electrode portion of an electronic component contacts the intermediate terminal portion.

FIG. 9 is a diagrammatic view illustrating a relationship between a deformation stroke and an elastic reaction force of the intermediate terminal portion.

FIG. 10 is a cross-sectional view illustrating an electronic component socket according to a second embodiment of the disclosure.

### DETAILED DESCRIPTION OF THE DISCLOSURE

The following description is intended to convey a thorough understanding of the embodiments described by providing a number of specific embodiments and details involving an electronic component socket. It should be appreciated, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending on specific design and other needs.

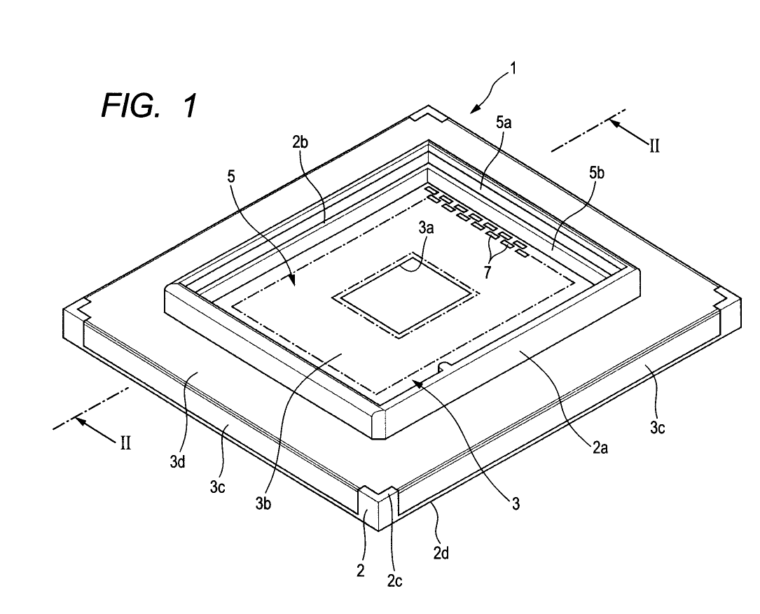

As shown in FIGS. 1 to 3, an electronic component socket 1 of an embodiment of the disclosure may include an insulating housing 2 and first and second metal sheets 3 and 4 which may be embedded in a housing 2. The housing 2 and two metal sheets 3 and 4 may be integrated with each other in accordance with so-called insert molding. That is, in a state where the first metal sheet 3 and the second metal sheet 4 may be combined and supported inside a cavity of a mold, a molten resin is injected into the cavity so as to form the housing 2 having two metal sheets 3 and 4 embedded therein.

As shown in FIGS. 1 to 3, a support side wall portion 2a may be formed in the upper portion of the housing 2, and an upper concave portion 5 of which four surfaces may be surrounded by the support side wall portion 2a is formed. A stepped bottom portion 2b may be formed in each inner surface of four surfaces of the support side wall portion 2a, and in the upper concave portion 5, an upper portion in relation to the stepped bottom portion 2b may become a component support portion 5a, and a lower portion in relation to the stepped bottom portion 2b may become a terminal deformation space 5b. A part of the first metal sheet 3 and the second metal sheet 4 may be positioned at the bottom portion of the upper concave portion 5, that is, the bottom portion of the terminal deformation space 5b.

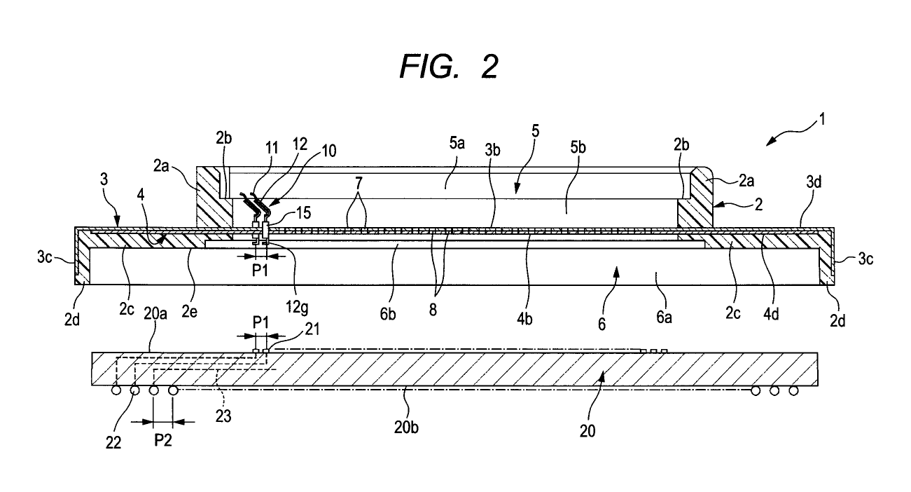

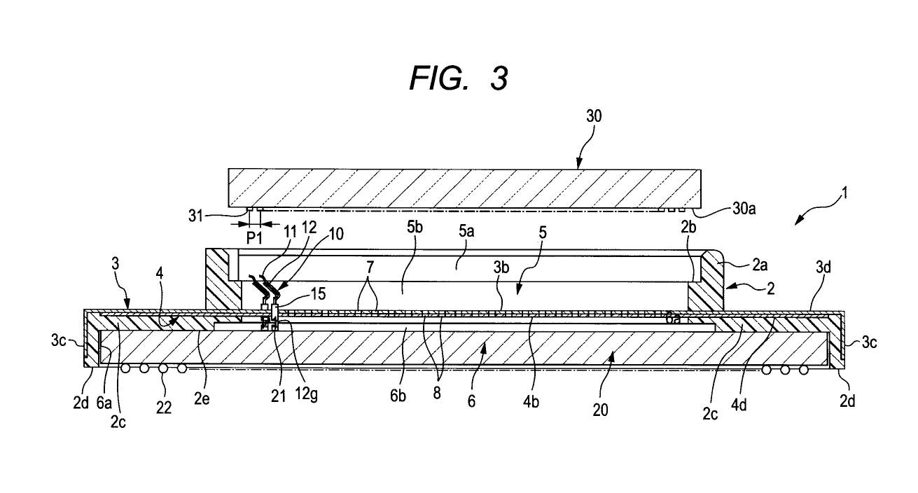

As shown in FIGS. 2 and 3, the housing 2 may be provided with a ceiling wall portion 2c which may project outward from the support side wall portion 2a in four directions, and may be integrally formed with an attachment side wall portion 2d which may extend downward from the periphery of the ceiling wall portion 2c, so that a lower concave portion 6 of which four surfaces are surrounded by the attachment side wall portion 2d may be formed. In the lower concave portion 6, lower portion in relation to a lower surface 2e of the ceiling wall portion 2c may become a connection member attachment portion 6a, and an upper portion in relation to the lower surface 2e may become a terminal connection space 6b. The housing 2 may have a structure in which the connection member attachment portion 6a projects outward from the component support portion 5a.

In the inside of the synthetic resinous housing 2, the upper concave portion 5 and the lower concave portion 6 may communicate with each other, and the upper concave portion 5 and the lower concave portion 6 may be divided by the first metal sheet 3 and the second metal sheet 4.

The first metal sheet 3 and the second metal sheet 4 may be formed of a metal sheet such as a steel sheet with a comparatively low resistance.

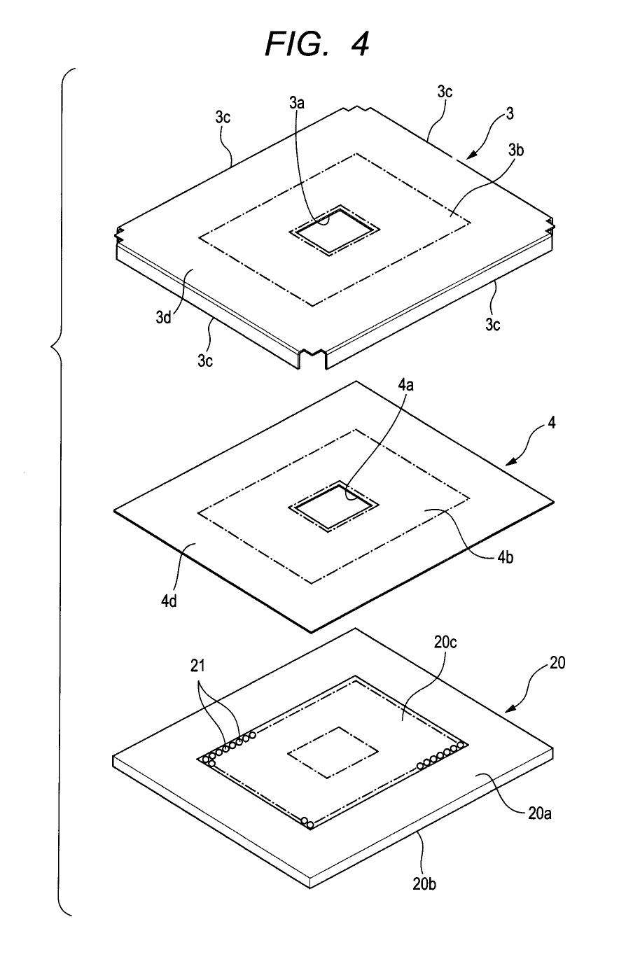

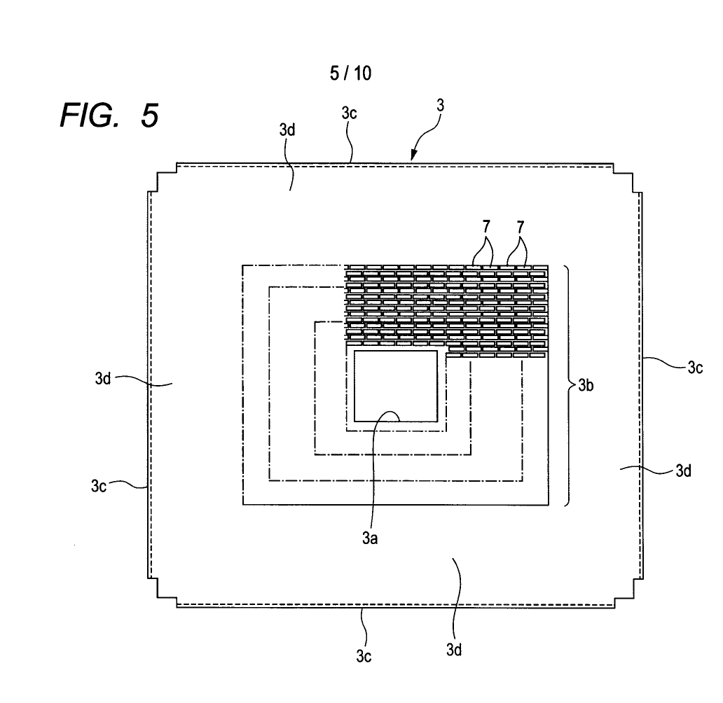

As shown in FIGS. 4 and 5, the first metal sheet 3 may have a rectangular shape in the top view. The center portion of the first metal sheet 3 may be provided with a rectangular center opening portion 3a with a small area, and a rectangular area which may surround the center opening portion 3a becomes a terminal holding portion 3b. Plural penetration holes 7 may be evenly arranged, for example, in the entire area of the rectangular area which may be the terminal holding portion 3b. Each penetration hole 7 may be a rectangular hole which may penetrate the first metal sheet 3.

As shown in FIGS. 4 and 5, the first metal sheet 3 may be provided with a ceiling shield surface 3d which may extend laterally in four directions from the surface which is flush with the terminal holding portion 3b and may be the terminal holding portion 3b. The penetration hole 7 may not be formed in the ceiling shield surface 3d. Four side shield surfaces 3c which may be bent from the ceiling shield surface 3d substantially at a right angle are formed at positions laterally distant in four directions from the terminal holding portion 3b.

As shown in FIG. 4, the second metal sheet 4 may be a flat sheet, and may have the same shape and size as those of the portion obtained by removing the side shield surface 3c from the first metal sheet 3. A rectangular center opening portion 4a may be formed at the center portion of the second metal sheet 4. The rectangular area around the center opening portion 4a may be a terminal holding portion 4b, and the outer peripheral portion may be integrally formed with a ceiling shield surface 4d. The shapes and the sizes of the center opening portion 4a and the terminal holding portion 4b may be the same as those of the center opening portion 3a and the terminal holding portion 3b of the first metal sheet 3.

As shown in FIGS. 2 and 3, plural penetration holes 8 may be formed in the terminal holding portion 4b of the second metal sheet 4. The opening areas, the shapes, and the arrangements of the penetration holes 8 may be the same as those of the penetration holes 7 which are formed in the terminal holding portion 3b of the first metal sheet 3.

The first metal sheet 3 and the second metal sheet 4 may be held inside the cavity of the mold while overlapping each other so that the center opening portion 3a matches the center opening portion 4a and the plural penetration holes 7 individually match the plural penetration holes 8. Furthermore, the second metal sheet 4 may overlap the lower surface side of the first metal sheet 3. Then, a molten resin may be injected into the cavity, thereby molding the housing 2.

As shown in FIGS. 1 to 3, in the electronic component socket 1 which may be molded by the above-described process, the center opening portion 3a and the terminal holding portion 3b of the first metal sheet 3 and the center opening portion 4a and the terminal holding portion 4b of the second metal sheet 4 may be positioned at the boundary portion between the upper concave portion 5 and the lower concave portion 6.

The ceiling shield surface 3d of the first metal sheet 3 and the ceiling shield surface 4d of the second metal sheet 4 may be positioned on the ceiling wall portion 2c of the housing 2, and the ceiling shield surface 3d of the first metal sheet 3 may be present at the outermost surface of the ceiling wall portion 2c. Further, the side shield surface 3c of the first metal sheet 3 may be present at the surface of the attachment side wall portion 2d. With regard to the connection member attachment portion 6a which may project toward the periphery in relation to the component support portion 5a, the ceiling portion and four side portions are covered by the metal sheet.

Plural intermediate terminal portions 10 which may be terminal portions are held by the terminal holding portion 3b of the first metal sheet 3 and the terminal holding portion 4b of the second metal sheet 4 embedded in the housing 2. Although the intermediate terminal portions 10 may be arranged in the entire areas of the terminal holding portion 3b and the terminal holding portion 4b, only a part of the intermediate terminal portion 10 is shown in FIGS. 2 and 3 for convenience of drawings.

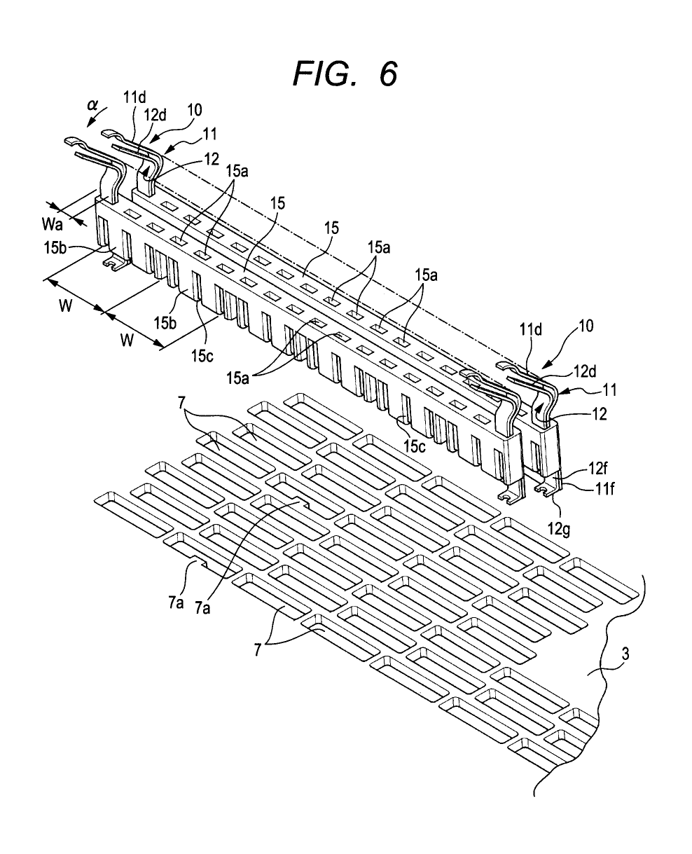

As shown in FIG. 6, the plural intermediate terminal portions 10 may be held by an insulation holding portion 15 which may be formed of a synthetic resin material. The insulation holding portion 15 may be formed in a thin and elongated bar shape, and holding holes 15a which may penetrate therethrough in the vertical direction are opened toward the longitudinal direction at a predetermined pitch. The respective intermediate terminal portions 10 may be individually pressed into the holding holes 15a so as to be held therein. Also, the insulation holding portion 15 and the plural intermediate terminal portions 10 may be integrated with each other by so-called insert molding.

As shown in FIG. 6, the insulation holding portion 15 may be integrally formed with plural convex portions 15b which may be separated from each other so as to have a constant width W in the longitudinal direction and protrude downward. Each convex portion 15b may include two holding holes 15a, and the insulation holding portion 15 holds two pairs of intermediate terminal portions 10 in the range of the width W.

The convex portion 15b may be formed with dimensions which allow the convex portions to be individually press-inserted into the penetration holes 7 formed in the terminal holding portion 3b of the first metal sheet 3 and the penetration hole 8 formed in the terminal holding portion 4b of the second metal sheet 4. Each convex portion 15b may be press-inserted into two penetration holes 7 and 8 arranged at the upper and lower sides, so that the plural intermediate terminal portions 10 may be held in the area of the terminal holding portion 3b and the terminal holding portion 4b.

The intermediate terminal portion 10 which may be used to transmit a signal line may be insulated from two metal sheets 3 and 4 by the insulation holding portion 15. As shown in FIG. 6, in the insulation holding portion 15, a concave portion 15c to which the intermediate terminal portion 10 serving as at least an earth terminal is exposed may be formed at the side portion of the convex portion 15b. A conductive protrusion 7a which integrally may protrude from the inner peripheral edge portion of a part of the penetration hole 7 formed in the metal sheet 3 is formed in a portion which faces the concave portion 15c. When the insulation holding portion 15 is held by the penetration hole 7, the conductive protrusion 7a may be inserted into the concave portion 15c so as to contact the intermediate terminal portion 10, and the first metal sheet 3 may be set to the same potential as that of the intermediate terminal portion 10 which serves as the earth terminal.

Further, a conductive protrusion may be formed in the inner peripheral edge portion of the penetration hole 8 of the second metal sheet 4, and the second metal sheet 4 may be electrically connected to the intermediate terminal portion 10 which may serve as the earth terminal.

Since the first metal sheet 3 and the second metal sheet 4 may be electrically connected to each other while overlapping each other, when any one of the first metal sheet 3 and the second metal sheet 4 is electrically connected to the intermediate terminal 10, both metal sheets 3 and 4 may be set to the ground potential.

Also, both the penetration hole 7 of the first metal sheet 3 and the penetration hole 8 of the second metal sheet 4 may be provided with the conductive protrusions and the respectively conductive protrusions may be electrically connected to the intermediate terminal 10. In this case, the conductive protrusion 7a of the first metal sheet 3 and the conductive protrusion of the second metal sheet may be formed at a position where the conductive protrusions overlap each other so as to be electrically connected to the same intermediate terminal 10. The conductive protrusion 7a of the first metal sheet 3 and the conductive protrusion of the second metal sheet also may be formed at different positions so as to be electrically connected to different intermediate terminals 10.

Since the terminal holding portion 3b of the first metal sheet 3 and the terminal holding portion 4b of the second metal sheet 4 may be positioned so as to overlap each other at the boundary portion between the upper concave portion 5 and the lower concave portion 6 of the housing 2, the high strengths of the terminal holding portions 3b and 4b positioned inside the inner space of the housing 2 may be maintained and it may be difficult for the bending of the terminal portion to arise. Further, since the convex portion 15b of the insulation holding portion 15 which holds the intermediate terminal portion 10 may be held by the penetration holes 7 and 8 of two metal sheets 3 and 4 which overlap each other at the upper and lower sides, the holding strength of the insulation holding portion 15 increases.

As the process of assembling the intermediate terminal portion 10, first, the first metal sheet 3 and the second metal sheet 4 overlap each other, the convex portion 15b of the insulation holding portion 15 may be press-inserted into the penetration holes 7 and 8, and a resin may be injected into the cavity of the mold while the first metal sheet 3 and the second metal sheet 4 holding the intermediate terminal portion 10 may be held inside the cavity, thereby forming the housing 2. Also, as the process after the housing 2 having the first metal sheet 3 and the second metal sheet 4 embedded therein is formed, the insulation holding portion 15 may be press-inserted into the penetration holes 7 and 8 of the terminal holding portions 3b and 4b.

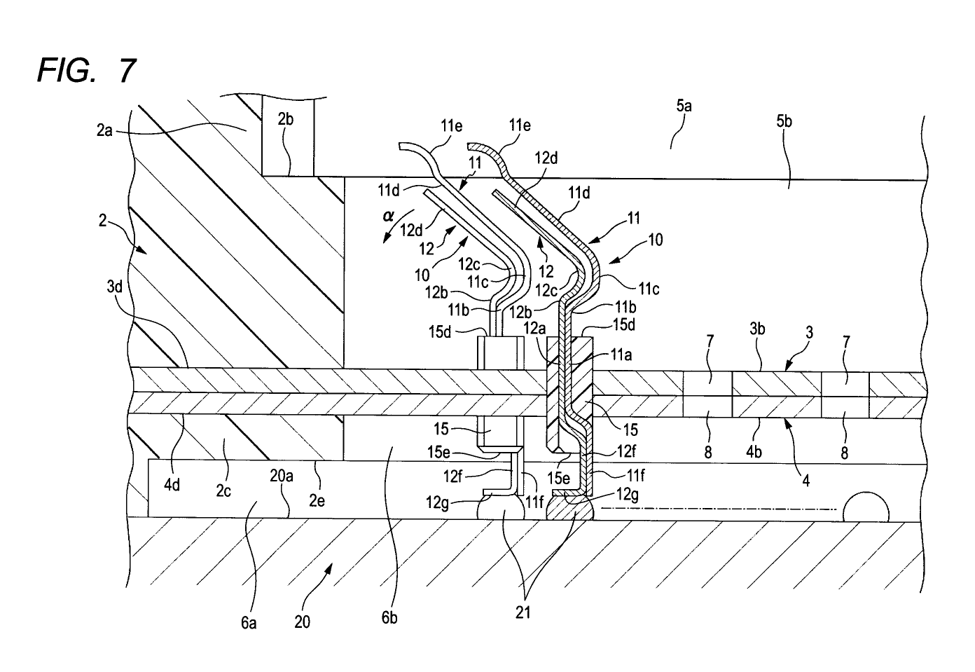

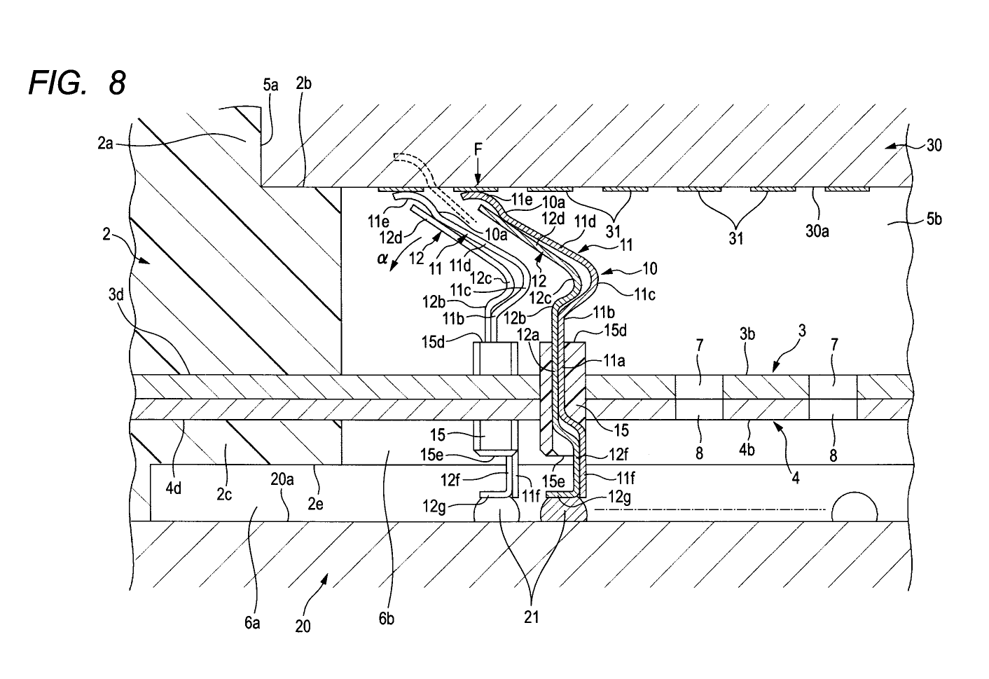

As shown in the enlarged views of FIGS. 7 and 8, the respective intermediate terminal portions 10 may be formed so that the first metal piece 11 and the second metal piece 12 overlap each other. The first metal piece 11 and the second metal piece 12 may be formed of a plate spring material such as a phosphor-bronze plate. Then, a nickel plated layer may be formed on the surface and further a gold plated layer may be formed on the surface thereof.

The first metal piece 11 may include a first support piece 11a, and the second metal piece 12 may include a second support piece 12a. The first support piece 11a and the second support piece 12a may overlap each other in the sheet thickness direction, and may be held by the insulation holding portion 15 while coming into close contact with each other. Since the first support piece 11a and the second support piece 12a may come into close contact with each other, the first metal piece 11 and the second metal piece 12 normally have the same potential.

In the first metal piece 11, a bent portion 11b may be formed at a position distant from an upper surface 15d of the insulation holding portion 15, a curved portion 11c may be formed at the upper portion in relation to the bent portion 11b, and a flat portion 11d may be integrally formed so as to be continuous from the upper end of the curved portion 11c. A bent contact portion 11e may be integrally formed with the front portion of the flat portion 11d.

In the second metal piece 12, a bent portion 12b may be formed at a position distant from the upper surface 15d of the insulation holding portion 15, a curved portion 12c may be formed at the upper portion in relation to the bent portion 12b, and a flat portion 12d integrally may extend from the upper end of the curved portion 12c.

As shown in FIGS. 7 and 8, the first metal piece 11 and the second metal piece 12 may come into close contact with each other in the range from the upper surface 15d of the insulation holding portion 15 to the bent portions 11b and 12b, so that the bending rigidity of the portion is high and the portion is not easily deformed. That is, the lower portions of the bent portions 11b and 12b are the first support piece 11a and the second support piece 12a.

As shown in FIG. 7, when a load F which is an external force is not exerted on the intermediate terminal portion 10, the first metal piece 11 and the second metal piece 12 may be separated from each other in the range from the bent portions 11b and 12b to the respective front end portions. That is, the first metal piece 11 and the second metal piece 12 may be separated from each other at the curved portions 11c and 12c and the flat portions 11d and 12d.

In the first metal piece 11, the curved portion 11c and the flat portion 11d are main elastic deformation areas, and the curved portion 11c and the flat portion 11d which are in front of the bent portion 11b may serve as a first elastic piece. Even in the second metal piece 12, the curved portion 12c and the flat portion 12d may be main elastic deformation areas, and the curved portion 12c and the flat portion 12d which are in front of the bent portion 12b may serve as a second elastic piece.

The curved portion 11c of the first metal piece 11 may serve as a bending beam, and the flat portion 11d may serve as a simple beam. When the downward load F is exerted in the contact portion 11e, the curved portion 11c and the flat portion 11d may be mainly bent, so that the first metal piece 11 may be bent toward the first side (a direction). Even in the second metal piece 12, the curved portion 12c may serve as a bending beam, and the flat portion 12d may serve as a simple beam.

As shown in FIG. 6, the widths of the first elastic piece of the first metal piece 11 and the second elastic piece of the second metal piece 12 may be the same width Wa.

The first metal piece 11 and the second metal piece 12 which are positioned below the bent portion 11b overlap each other so as to improve the rigidity and the curved portion 11c may be positioned thereabove. Accordingly, when the first metal piece 11 is bent toward the first side (a direction), the bending stress may be distributed to the curved portion 11c, thereby preventing an excessive stress from concentrating on the portion which may protrude from the upper surface 15d of the insulation holding portion 15. Further, since the curved portion 11c is provided, even when the upper dimension from the upper surface 15d of the insulation holding portion 15 to the contact portion 11e is set to be short, the substantial free length of the first elastic piece of the portion in front of the bent portion 11b may be lengthened. The same may applies to the second elastic piece of the second metal piece 12.

As shown in FIG. 7, when the downward load F is not exerted in the intermediate terminal portion 10, the contact portion 11e of the first metal piece 11 may be positioned inside the component support portion 5a of the housing 2, and a portion where the first metal piece 11 and the second metal piece 12 are separated and face each other may be positioned inside the terminal deformation space 5b.

As shown in FIGS. 7 and 8, the first metal piece 11 may be integrally formed with a base end piece 11f which protrudes downward from the lower surface 15e of the insulation holding portion 15, and the second metal piece 12 may be integrally formed with a base end piece 12f which protrudes downward from the lower surface 15e of the insulation holding portion 15. The base end piece 11f and the base end piece 12f may come into close contact with each other. Then, the lower end portion of the base end piece 12f of the second metal piece 12 may be bent at a right angle, thereby forming a conductive piece 12g. The conductive piece 12g may be positioned inside the terminal connection space 6b in the housing 2.

As shown in FIGS. 2 and 3, the connection member 20 may be held by the connection member attachment portion 6a of the electronic component socket 1.

The connection member 20 may be a connector board, where plural upper connection electrode portions 21 are arranged in the upper surface 20a, and plural lower connection electrode portions 22 are arranged in the lower surface 20b. The upper connection electrode portion 21 may include a spherical solder layer which may be formed in the surface thereof. The lower connection electrode portion 22 also may include a spherical solder layer which may be formed in the surface thereof.

As shown in FIG. 4, the upper surface 20a of the connection member 20 may be provided with a rectangular electrode arrangement area 20c, and plural upper connection electrode portions 21 are evenly arranged in the electrode arrangement area 20c. The shape and the area of the electrode arrangement area 20c may be the same as those of the areas of the terminal holding portion 3b of the first metal sheet 3 and the terminal holding portion 4b of the second metal sheet 4. Further, the arrangement of the upper connection electrode portions 21 may be the same as that of the intermediate terminal portions 10, and the arrangement pitch P1 of the upper connection electrode portions 21 may be the same as the arrangement pitch P1 of the intermediate terminal portions 10.

The connection member 20 may be a so-called multi-layer substrate, and may include plural insulating layers which are stacked in the thickness direction. As shown in FIG. 2, an inner interconnection layer 23 may be patterned on the surface of each layer inside the connection member 20, and the upper connection electrode portions 21 and the lower connection electrode portions 22 may be electrically connected to each other according to a one-to-one relationship through the inner interconnection layer 23. Then, the arrangement pitch P2 of the lower connection electrode portions 22 may be formed so as to be wider than the arrangement pitch P1 of the upper connection electrode portions 21.

As shown in FIG. 3, the connection member 20 may be inserted into the connection member attachment portion 6a of the housing 2. When the connection member 20 is inserted into the attachment side wall portion 2d and is brought into contact with the lower surface 2e of the ceiling wall portion 2c, the connection member 20 may be positioned with respect to the housing 2, and the conductive piece 12g of each intermediate terminal portion 10 may come into contact with the upper connection electrode portion 21 of the connection member 20. When this assembly is supplied to the heating furnace in this state, the solder layer of the surface of the upper connection electrode portions 21 may be melted, and the upper connection electrode portions 21 and the conductive pieces 12g of the intermediate terminal portions 10 may be individually soldered, so that the connection member 20 may be held in the housing 2.

Also, a spherical solder layer may be attached in advance to a portion which may face the upper connection electrode portions 21 of the conductive pieces 12c, the solder layer and the upper connection electrode portions 21 may be supplied to the heating furnace while coming into contact with each other, and the solder layer may be melted so that the upper connection electrode portions 21 and the conductive pieces 12c are soldered.

In the main board on which the electronic component socket 1 is mounted, the surface may be provided with main electrode portions, and the main electrode portions may be disposed at the same pitch as the arrangement pitch P2 of the lower connection electrode portions 22 of the connection member 20. When the solder layer of the lower connection electrode portions 22 is melted while the lower connection electrode portions 22 of the connection member 20 individually face the main electrode portion, the lower connection electrode portions 22 and the main electrode portion may be individually soldered, and the electronic component socket 1 may be mounted on the main board through the connection member 20.

Further, since the earth terminal of the plural intermediate terminal portions 10 is electrically connected to two metal sheets 3 and 4 by the conductive protrusion 7a shown in FIG. 6, two metal sheets 3 and 4 may be set to the ground potential.

Since the arrangement pitch P2 of the lower connection electrode portions 22 is wider than the arrangement pitch P1 of the intermediate terminal portions 10, it may be possible to widen the pitch of the main electrode portion of the main board and to reduce the manufacturing cost of the main board by decreasing the number of layers of the main board which is the multi-layer substrate.

As shown in FIGS. 3 and 8, the electronic component 30 may be attached to the electronic component socket 1 which may be mounted on the main board. The electronic component 30 may be an IC bare chip or an IC package. Plural component electrode portions 31 may be formed in the bottom surface 30a of the electronic component 30. The surface of the component electrode portion 31 may be formed as a metal layer which is a flat surface. The arrangement area of the component electrode portions 31 in the bottom surface 30a of the electronic component 30 may be the same as the area where plural intermediate terminal portions 10 are arranged. The arrangement pitch P1 of the component electrode portions 31 may be the same as the arrangement pitch P1 of the intermediate terminal portions 10.

The electronic component 30 may be inserted into the component support portion 5a of the electronic component socket 1, and may be positioned so as not to move in the plane direction while being surrounded by the support side wall portion 2a, so that the component electrode portions 31 and the intermediate terminal portions 10 individually face each other at the upper and lower sides. Then, the electronic component 30 may be pressed and fixed from the upper side by a pressing member (not shown).

When the electronic component 30 is inserted into the component support portion 5a, the component electrode portion 31 may come into contact with the contact portion 11e of the first metal piece 11 which may protrude into the component support portion 5a as shown in FIG. 7. When the electronic component 30 is press-inserted, the downward load F may be applied to the contact portion 11e. Accordingly, first, only the first metal piece 11 may be bent toward the first side (α direction), and then the first metal piece 11 and the second metal piece 12 may come into contact with each other so that the second metal piece is also bent toward the first side (α direction).

In the first metal piece 11 and the second metal piece 12, the portions which are in front of the bent portions 11b and 12b may be separated from each other. Accordingly, when the load F starts to be exerted, the first metal piece 11 may be deformed without a problem in which the first elastic piece including the curved portion 11c and the flat portion 11d does not contact the second metal piece 12. When the elastic reaction force which is exerted from the curved portion 11c and the flat portion 11d of the first metal piece 11 on the component electrode portion 31 is set to be comparatively small, the electronic component 30 may be press-inserted into the component support portion 5a by a comparatively small force.

While the first metal piece 11 is bent toward the first side (α direction), the flat portion 11d of the first metal piece 11 and the flat portion 12d of the second metal piece 12 may come into contact with each other at the contact portion 10a, and then the first metal piece 11 and the second metal piece 12 may be bent together toward the first side (a direction). The contact portion 10a where two elastic pieces come into contact with each other corresponds to one position in the longitudinal direction of the first elastic piece and the second elastic piece (the direction from the curved portion toward the flat portion), and this state may be maintained while the first elastic piece and the second elastic piece are bent together.

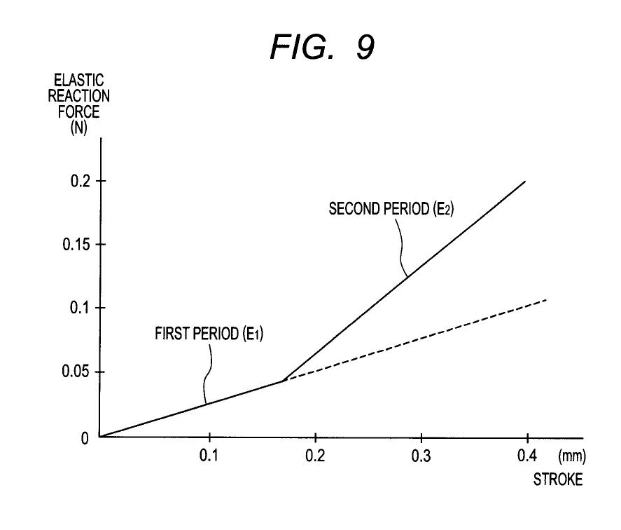

In the diagrammatic view of FIG. 9, the horizontal axis indicates the downward movement distance of the contact portion 11e, and the vertical axis indicates the elastic reaction force which is applied from the contact portion 11e to the component electrode portion 31. As shown in the diagrammatic view, only the first metal piece 11 may be bent during a first period in which the component electrode portion 31 contacts the contact portion 11e, and the spring constant of the intermediate terminal portion 10 at this time is E1. After the first metal piece 11 and the second metal piece 12 come into contact with each other, both the first metal piece 11 and the second metal piece 12 may be bent. Accordingly, in a second period, the spring constant is E2. Since the first metal piece 11 and the second metal piece 12 may have the same sheet thickness and width Wa, the spring constant E2 becomes approximately 2×E1.

As shown in FIG. 8, when the electronic component 30 is positioned by being pressed by the stepped bottom portion 2b, the contact portion 11e may come into press-contact with the component electrode portion 31 by the spring constants E2 of the first metal piece 11 and the second metal piece 12. When the elastic reaction force at this time is set to be sufficiently large, the contact portion 11e may be reliably brought into contact with the component electrode portion 31 and the conductive resistance may be decreased.

As shown in FIG. 8, when the first metal piece 11 and the second metal piece 12 are bent toward the first side (a direction), the downward load F which is applied from the component electrode portion 31 may be exerted as F/2 in each of the first metal piece 11 and the second metal piece 12.

When the arrangement pitch P1 of the component electrode portions 31 of the electronic component 30 is short, the upward dimensions of the intermediate terminal portion 10 from the insulation holding portion 15 may need to be short and the bent amount of the intermediate terminal portion when being pressed by the component electrode portion 31 may need to be small. Here, if the intermediate terminal portion 10 is formed as one plate spring, the spring constant increases when the free length is set to be short. For this reason, in order to make the spring constant small, the second moment of area of the plate spring needs to be small. As a result, the section modulus may decrease, and the maximal stress which is obtained by (bending moment)/(section modulus) may increase.

However, as shown in FIGS. 7 and 8, since the load F is received while being distributed to two metal pieces 11 and 12, the bending moment which is exerted in each of the metal pieces 11 and 12 may be set to be almost a half of the case of one plate spring. As a result, the maximal stress may be reduced. Accordingly, the spring constant E2 using the first metal piece 11 and the second metal piece 12 may be set to an appropriate value, and the intermediate terminal portion 10 may be set to be short, so that the strength and the lifespan of each of the metal pieces 11 and 12 may be improved.

As shown in FIGS. 7 and 8, when the first metal piece 11 and the second metal piece 12 are bent toward the first side (a direction), the front end portion of the second metal piece 12 may not protrude from the front end portion of the first metal piece 11. Accordingly, even when the intermediate terminal portion 10 is formed in a double-layer structure, the space necessary for bending may not increase in size.

Further, when the first metal piece 11 and the second metal piece 12 are deformed toward the first side (α direction), the first metal piece 11 and the second metal piece 12 normally may come into contact with each other at one contact portion 10a in the longitudinal direction, and in the portions which are in front of the bent portions 11b and 12b, two metal pieces 11 and 12 may not come into contact with each other in the other positions. The contact portion 10a may be the boundary portion between the flat portion 11d and the contact portion 11e of the first metal piece 11.

Since the first metal piece 11 and the second metal piece 12 are deformed while coming into contact with each other at one contact portion 10a, the frictional resistance caused by the contact when two metal pieces 11 and 12 are deformed may be decreased, and a variation in the reaction force in the plural intermediate terminal portions 10 may be prevented.

Further, since the intermediate terminal portion 20 includes two metal pieces 11 and 12, the electrical resistance of the intermediate terminal portion 20 may be decreased.

In the electronic component socket 1, since plural intermediate terminal portions 10 penetrate the plural penetration holes 7 and 8 formed in two metal sheets 3 and 4, the intermediate terminal portions 10 may be shielded from each other by two metal sheets 3 and 4, and external noise may not be easily superimposed on the signal which is transmitted from the intermediate terminal portion 10.

Since the connection member 20 may have a structure in which the upper surface is covered by two metal sheets 3 and 4 and four side portions are covered by the side shield surface 3c, the conductive portion between the upper connection electrode portions 21 of the connection member 20 and the intermediate terminal portions 10, the connection portion between the lower connection electrode portions 22 and the main electrode portion of the main board, and the inner interconnection layer 23 may be shielded, and the signal which is transmitted through the connection member 20 may be easily protected from external noise.

As shown in FIGS. 2 and 3, in the connection member 20, the arrangement pitch P2 of the lower connection electrode portions 22 which are connected to the main board may be wider than the arrangement pitch P1 of the upper connection electrode portions 21 which may be connected to the intermediate terminal portions 10. Accordingly, the connection member attachment portion 6a provided with the connection member 20 may have a shape which protrudes laterally in relation to the component support portion 5a. Since the ceiling portion of the protruding portion is covered by the ceiling shield surfaces 3d and 4d and the side portion is covered by the side shield surface 3c, the portion which exceeds from the electronic component 30 of the connection member 20 may be effectively shielded, and the signal which is transmitted from the connection member 20 may be protected.

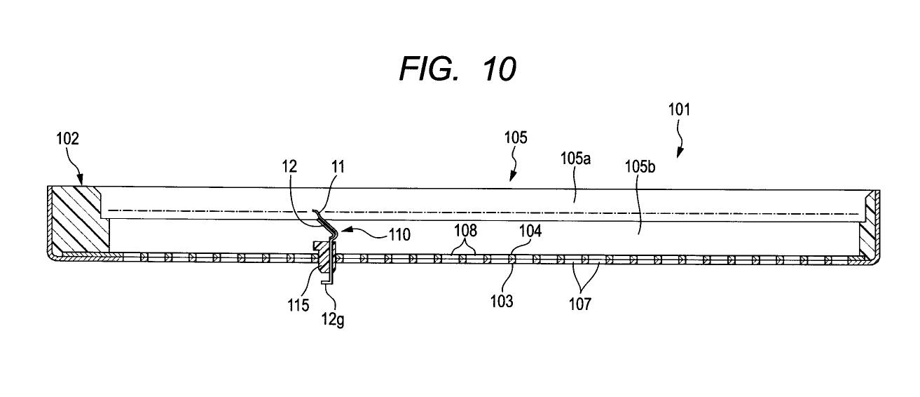

In an electronic component socket 101 of an embodiment shown in FIG. 10, an upper concave portion 105 may be formed in a synthetic resinous housing 102, and the inside thereof may be formed as a component support portion 105a and a terminal deformation space 105b. A first metal sheet 103 and a second metal sheet 104 may overlap each other and may be installed in the bottom portion of the housing 102, so that the metal sheets 103 and 104 and the housing 102 may be integrally fixed. A penetration hole 107 may be formed in the first metal sheet 103 and a penetration hole 108 may be formed in the second metal sheet 104, so that the insulation holding portion 15 is held in the penetration holes 107 and 108.

The structure of the intermediate terminal portion 10 which is held in the insulation holding portion 15 may be the same as that of FIGS. 6 to 8, for example, and the intermediate terminal portion may include the first metal piece 11 and the second metal piece 12. The conductive piece 12g which is integrally formed with the lower end of the second metal piece 12 may protrude downward from the first metal sheet 103.

The electronic component socket 101 shown in FIG. 10 may not be provided with the connection member attachment portion 6a, and the first metal sheet 103 may be present in the bottom surface of the socket. The electronic component socket 101 may be directly installed on the main board without using the connection member 20, and the conductive pieces 12g may be individually soldered to the main electrode portion installed in the main board.

Furthermore, in the above-described embodiments, the intermediate terminal portion 10 may include two metal pieces 11 and 12. However, the intermediate terminal portion 10 may be formed by bending one metal sheet, one bent piece may be provided with the first support piece 11a, the curved portion 11c, the flat portion 11d, and the contact portion lie, and the other bent piece may be provided with the curved portion 12c and the flat portion 12d.

Further, a third metal piece which further reinforces the second metal piece 12 may be provided.

Furthermore, the socket may not be provided with two metal sheets 3 and 4 or the metal sheets 103 and 104, and the insulation holding portion 15 which holds the intermediate terminal portion 10 may be integrally formed with the synthetic resinous housing 2.

It should be understood by those skilled in the art that various modifications, combinations, sub-combinations and alterations may occur depending on design requirements and other factors insofar as they are within the scope of the appended claims of the equivalents thereof.

Accordingly, the embodiments of the present inventions are not to be limited in scope by the specific embodiments described herein. Further, although some of the embodiments of the present disclosure have been described herein in the context of a particular implementation in a particular environment for a particular purpose, those of ordinary skill in the art should recognize that its usefulness is not limited thereto and that the embodiments of the present inventions can be beneficially implemented in any number of environments for any number of purposes. Accordingly, the claims set forth below should be construed in view of the full breadth and spirit of the embodiments of the present inventions as disclosed herein. While the foregoing description includes many details and specificities, it is to be understood that these have been included for purposes of explanation only, and are not to be interpreted as limitations of the invention. Many modifications to the embodiments described above can be made without departing from the spirit and scope of the invention.

What is claimed is:

1. An electronic component socket comprising:
a housing that includes a component support portion in which an electronic component is able to be installed; and
terminal portions that are fixed to the housing and are able to contact a plurality of component electrode portions provided in a bottom surface of the electronic component,
wherein each terminal portion includes a support piece fixed to an insulation holding portion inside the housing and first and second elastic pieces extending from the insulation holding portion toward the component support portion,
wherein when the electronic component is installed in the component support portion, the first elastic piece is bendable toward a first side by being pressed against the component electrode portion,
wherein the second elastic piece is positioned at the first side in relation to the first elastic piece and when an external force is not exerted in the terminal portion, the second elastic piece is separated from the first elastic piece in a range of a predetermined distance from the front end portion toward the insulation holding portion, and
wherein when the first elastic piece is deformed toward the first side by a predetermined distance, the first elastic piece and the second elastic piece contact each other.

2. The electronic component socket according to claim 1,
wherein when the external force is not exerted in the terminal portion, the front end portion of the second elastic piece is positioned near the insulation holding portion in relation to the front end portion of the first elastic piece.

3. The electronic component socket according to claim 1,
wherein both the first elastic piece and the second elastic piece include a curved portion near the insulation holding portion, and when the external force is not exerted in the terminal portion, the second elastic piece is separated from the first elastic piece in a range from the front end portion to the curved portion.

4. The electronic component socket according to claim 1,
wherein when the first elastic piece is deformed by being pressed against the component electrode portion, the first elastic piece and the second elastic piece are elastically deformed toward the first side while contacting each other at one position in the longitudinal direction.

5. The electronic component socket according to claim 1,
wherein the terminal portion includes first and second metal pieces which are independent of each other, the first metal piece is integrally formed with the first elastic piece and a first support piece, the second metal piece is integrally formed with the second elastic piece and a second support piece, and the first support piece and the second support piece are held in the insulation holding portion while coming into close contact with each other.

6. The electronic component socket according to claim 1,
wherein the terminal portion is provided with a base end piece that extends from the insulation holding portion toward the opposite side of the component support portion, and the base end piece is provided with a conductive piece that is connected to a connection electrode portion facing the opposite side of the component support portion.

7. The electronic component socket according to claim 1,
wherein a metal sheet is held inside the housing, and the insulation holding portion holding a plurality of the terminal portions is held in a penetration hole of the metal sheet.
